(19) United States
(12) Patent Application Publication
(10) Pub. No.: US 2012/0257923 A1
(43) Pub. Date: Oct. 11, 2012

(54) MODULAR TUBE ASSEMBLY

(76) Inventor: Lung-Chang Tsai, Taichung City (TW)

(21) Appl. No.: 13/081,987

(22) Filed: Apr. 7, 2011

(51) Int. Cl. F16B 7/04

(52) U.S. Cl. 403/238

(57) ABSTRACT

A modular tube assembly includes first and second upright tubes and at least one connecting rod unit. The at least one connecting rod unit includes a connecting rod and at least one spring-loaded pin. The connecting rod interconnects the first and second upright tubes, and has a first end corresponding in position to at least one engaging hole of the first upright tube, and a second end corresponding in position to at least one engaging hole of the second upright tube. The at least one spring-loaded pin has a securing portion secured to one of the first and second ends of the connecting rod, and a movable portion movable resiliently relative to the securing portion and engaging removably the at least one engaging hole of a respective one of the first and second upright tubes.

### BACKGROUND OF THE INVENTION

1. Field of the Invention

The invention relates to a modular tube assembly, more particularly to a modular tube assembly for assembling tubular furniture parts.

2. Description of the Related Art

As shown in FIG. 1, a conventional tube assembly includes a pair of upright tubes 11, and a plurality of connecting rods 12 interconnecting the upright tubes 11. The opposite ends of each of the connecting rods 12 are generally and respectively welded to the upright tubes 11. However, it is troublesome to have the opposite ends of each connecting rod 12 welded respectively and precisely to selected positions of the upright tubes 11. Moreover, the conventional tube assembly can not be disassembled, thereby resulting in inconvenience when transporting the conventional tube assembly.

Referring to FIG. 2, a conventional modular tube assembly includes a pair of upright tubes 121, a plurality of connecting rods 122 interconnecting the upright tubes 121, and a plurality of securing bolts 123 for securing opposite ends of the connecting rods 122 to the respective upright tubes 121. Each of the upright tubes 121 has a plurality of depressed portions 1211 corresponding in position to the connecting rods 122, respectively, and a plurality of through holes 1212 formed respectively in the depressed portions 1211. Each of the securing bolts 123 is disposed to extend through a respective one of the depressed portions 1211 of a respective one of the upright tubes 121 and into an end of a respective one of the connecting rods 122. However, it is still inconvenient to assemble this conventional modular tube assembly using the securing bolts 123.

### SUMMARY OF THE INVENTION

Therefore, the object of the present invention is to provide a modular tube assembly that is easy to assemble.

Accordingly, a modular tube assembly of the present invention comprises first and second upright tubes and at least one connecting rod unit. The first and second upright tubes are spaced apart from each other. Each of the first and second upright tubes is formed with at least one engaging hole. The at least one engaging hole of the first upright tube is registered with the at least one engaging hole of the second upright tube. The at least one connecting rod unit includes a connecting rod and at least one spring-loaded pin. The connecting rod interconnects the first and second upright tubes, and has a first end that corresponds in position to the at least one engaging hole of the first upright tube, and a second end that is longitudinally opposite to the first end and that corresponds in position to the at least one engaging hole of the second upright tube. The at least one spring-loaded pin has a securing portion that is secured to one of the first and second ends of the connecting rod, and a movable portion that is movable resiliently relative to the securing portion and that engages removably the at least one engaging hole of a respective one of the first and second upright tubes.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary perspective view of a conventional tube assembly;

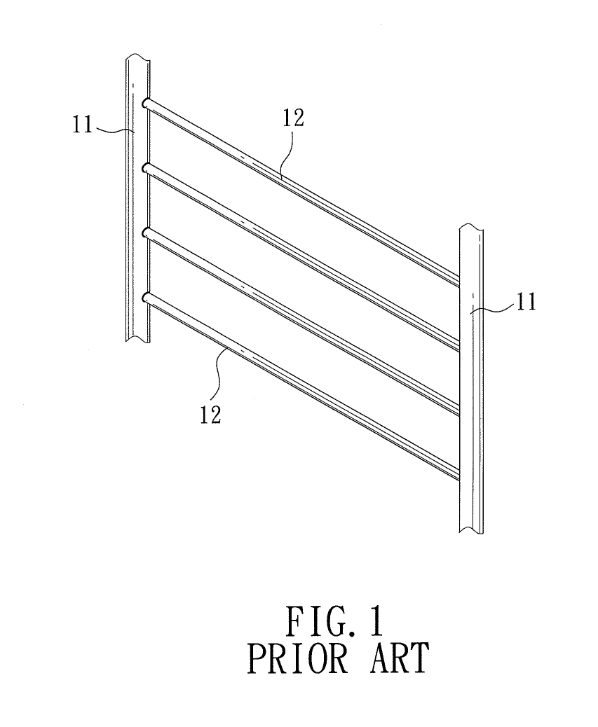

FIG. 2 is fragmentary schematic sectional view of a conventional modular tube assembly;

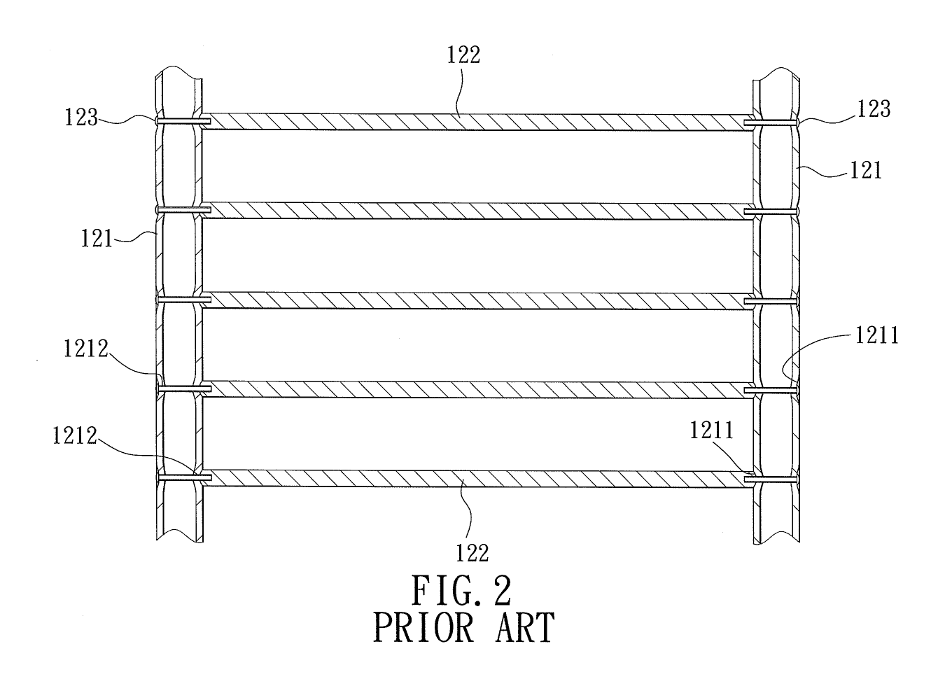

FIG. 3 is a fragmentary assembled perspective view of a first preferred embodiment of a modular tube assembly according to the invention;

FIG. 4 is a fragmentary exploded perspective view of the first preferred embodiment;

FIG. 5 is a fragmentary partly sectional view of the first preferred embodiment, illustrating a movable portion of a spring-loaded pin at a retracted position;

FIG. 6 is a view similar to FIG. 5, but illustrating the movable portion at an extended position;

FIG. 7 is a fragmentary exploded perspective view of a second preferred embodiment of the modular tube assembly according to the invention;

FIG. 8 is a fragmentary partly sectional view of the second preferred embodiment, illustrating a movable portion of a spring-loaded pin at a retracted position;

FIG. 9 is a view similar to FIG. 8, but illustrating the movable portion at an extended position;

FIG. 10 is a fragmentary partly sectional view of a third preferred embodiment of the modular tube assembly according to the invention;

FIG. 11 is a fragmentary partly exploded perspective view of a fourth preferred embodiment of the modular tube assembly according to the invention; and

FIG. 12 is a fragmentary partly sectional view of the fourth preferred embodiment.

### DETAILED DESCRIPTION OF THE PREFERRED EMBODIMENTS

Before the present invention is described in greater detail, it should be noted that like elements are denoted by the same reference numerals throughout the disclosure.

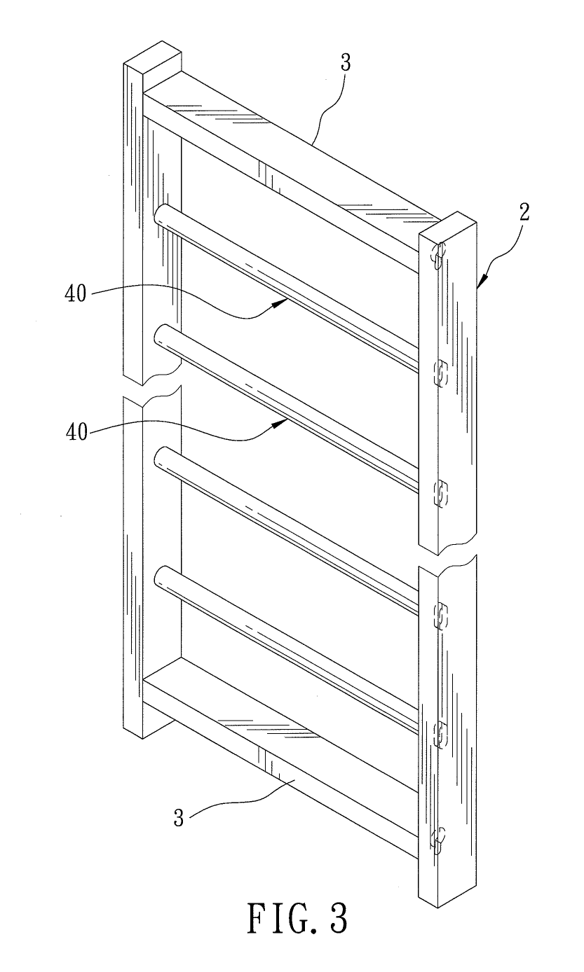

As shown in FIGS. 3 to 5, the first preferred embodiment of a modular tube assembly according to the present invention is adapted for connecting metallic tubular parts of furniture, such as bedsteads, chairs, cabinets, and so on. The modular tube assembly comprises an upright tube unit 2, a pair of coupling rods 3, and a plurality of connecting rod units 40.

The upright tube unit 2 includes first and second upright tubes 21, 22 spaced apart from each other. The first upright tube 21 is formed with a plurality of longitudinally spaced-apart first engaging holes 211, and a pair of first positioning holes 212 that are formed respectively above and below the first engaging holes 211. The second upright tube 22 is formed with a plurality of longitudinally spaced-apart second engaging holes 221 that are registered respectively with the first engaging holes 211 of the first upright tube 21, and a pair of second positioning holes 222 that are formed respectively above and below the second engaging holes 221 and that are registered respectively with the first positioning holes 212. Each of the first and second positioning holes 212, 222 has a main hole portion 213, 223, and an extending hole portion 214, 224 extending downwardly from and having a width smaller than that of the main hole portion 213, 223.

In this embodiment, one of the coupling rods 3 has a first end portion engaging the upper one of the first positioning holes 212 of the first upright tube 21, and a second end portion longitudinally opposite to the first end portion and engaging the corresponding one of the second positioning holes 222 of the second upright tube 22. The other one of the coupling rods 3 has a first end portion engaging the lower one of the first positioning holes 212, and a second end portion longitudinally opposite to the first end portion and engaging the corresponding one of the second positioning holes 222. Each of the coupling rods 3 has a main part having longitudinally opposite ends that are connected respectively to the first and second end portions. Each of the first and second end portions has a neck part 32 that has a cross-section smaller than the extending hole portion 214, 224 of a corresponding one of the first and second positioning holes 212, 222, that extends through the extending hole portion 214, 224 of the corresponding one of the first and second positioning holes 212, 222, and that has an inner end connected to a respective one of the ends of the main part 31 and an outer end longitudinally opposite to the inner end. Each of the first and second end portions further has a head part 33 that is connected to the outer end of the neck part 32, and that has a cross-section larger than the extending hole portion 214, 224 of the corresponding one of the first and second positioning holes 212, 222.

Each of the connecting rod units 40 includes a connecting rod 4 and a spring-loaded pin 5.

The connecting rod 4 of each of the connecting rod units 40 interconnects the first and second upright tubes 21, 22, and has first and second ends that correspond respectively in position to a respective pair of the registered first and second engaging holes 211, 221. In this embodiment, each connecting rod 4 has a hollow connecting segment 41 formed at the first end thereof and having a cross-section smaller than that of the corresponding one of the first engaging holes 211, a main segment 42 connected to the connecting segment 41, and an insert segment 43 formed at the second end thereof, and connected to and having a cross-section smaller than that of the main segment 42. In this embodiment, the cross-section of the insert segment 43 of each connecting rod 4 is elongated and configured to be substantially identical to the corresponding one of the second engaging holes 221 such that the insert segment 43 of each connecting rod 4 can be separably and non-rotatably inserted into the corresponding one of the second engaging holes 221. The cross-section of each insert segment 43 and the shape of each second engaging hole 221 may be configured to be other non-circular shapes in other embodiments of this invention.

The spring-loaded pin 5 of each connecting rod unit 40 has a securing portion 51, a movable portion 52, and a spring member 53. The securing portion 51 has a cross-section smaller than that of the connecting segment 41 of a respective one of the connecting rods 4 so as to be inserted thereinto and be secured thereto. The securing portion 51 includes an inner wall 511 disposed in the connecting segment 41 of the corresponding connecting rod 4, a hollow outer wall 512 spaced longitudinally apart from the inner wall 511 and connected to the first end of the corresponding connecting rod 4, and an intermediate wall 513 interconnecting the inner and outer walls 511, 512. The movable portion 52 is disposed movably in the securing portion 51 and extends movably through the outer wall 512. The spring member 53 is a compression spring disposed in the securing portion 51 and having opposite ends that abut respectively and resiliently against the inner wall 511 and the movable portion 52.

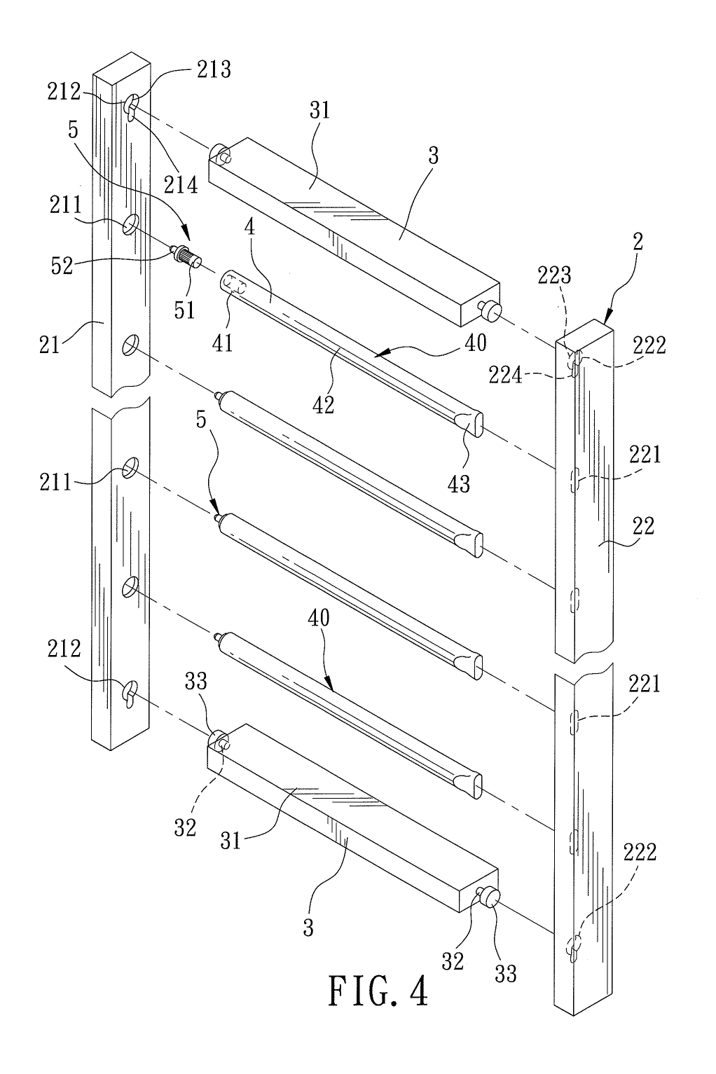

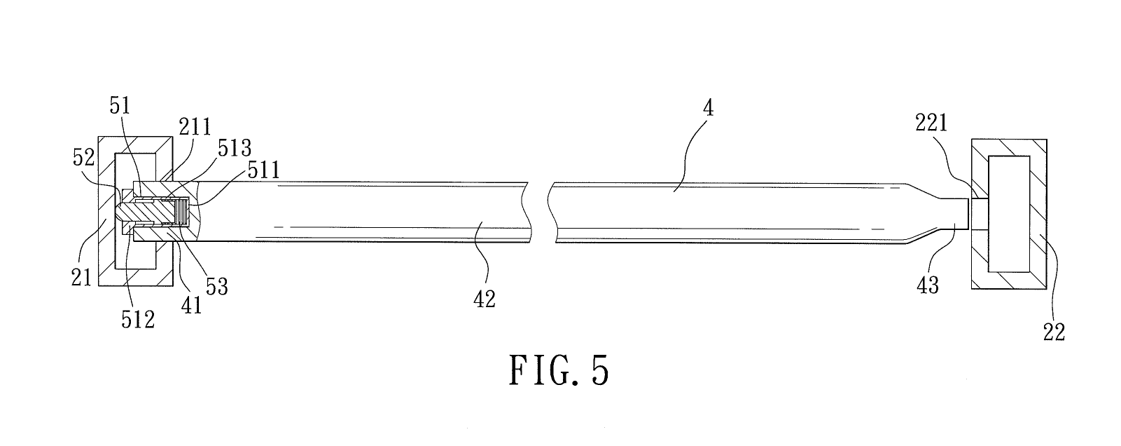

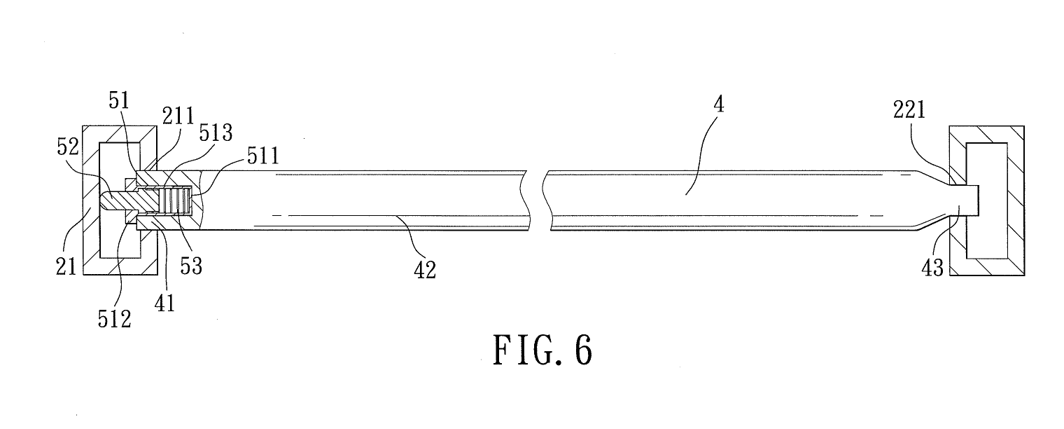

Referring once again to FIGS. 4 and 5, and further referring to FIG. 6, when assembling the modular tube assembly of this invention, each coupling rod 3 has to be placed at a position where the head parts 33 thereof are extended respectively through the main hole portions 213, 223 of the corresponding first and second positioning holes 212, 222, and then moved downwardly until the neck parts 32 thereof engage respectively the extending hole portions 214, 224 of the corresponding first and second positioning holes 212, 222, such that the coupling rods 3 are connected to the upright tube unit 2 and that the first and second upright tubes 21, 22 are positioned relative to each other. Afterward, when coupling each connecting rod unit 40 to the upright tube unit 2, the first end of the connecting rod 4 is inserted into the corresponding first engaging hole 211 and further pushed inwardly so that the movable portion 52 is urged by an inner surface of the first upright tube 21 to retract from an extended position (see FIG. 6), where the distal end of the movable portion 52 is away from the inner wall 511 of the securing portion 51, to a retracted position (see FIG. 5), where the distal end of the movable portion 52 is close to the inner wall 511, against the resilient force of the spring member 53, thereby permitting the insert segment 43 to be disposed at a position between the first and second upright tubes 21, 22 and adjacent to the corresponding second engaging hole 221. Finally, the connecting rod 4 is moved longitudinally toward the second upright tube 22 to insert the insert segment 43 fittingly into the corresponding second engaging hole 221, and the movable portion 52 is released to move resiliently back to the extended position by the restoring force of the spring member 53 while the connecting segment 41 still engages the corresponding first engaging hole 211 so as to complete the coupling of the connecting rod unit 40 to the upright tube unit 2.

On the contrary, each connecting rod unit 40 can be removed by moving the connecting rod 4 to thereby move the movable portion 52 to the retracted position, and disengaging the insert segment 43 from the corresponding second engaging hole 221.

Compared to the abovementioned conventional modular tube assembly, each of the connecting rod units 40 of this invention has a simpler structure, and can be easily and quickly coupled to and removed from the upright tube unit 2 without the use of any tool. In addition, the presence of the coupling rods 3 further enhances the structural stability of the upright tube unit 2 while being coupled with the connecting rod units 40.

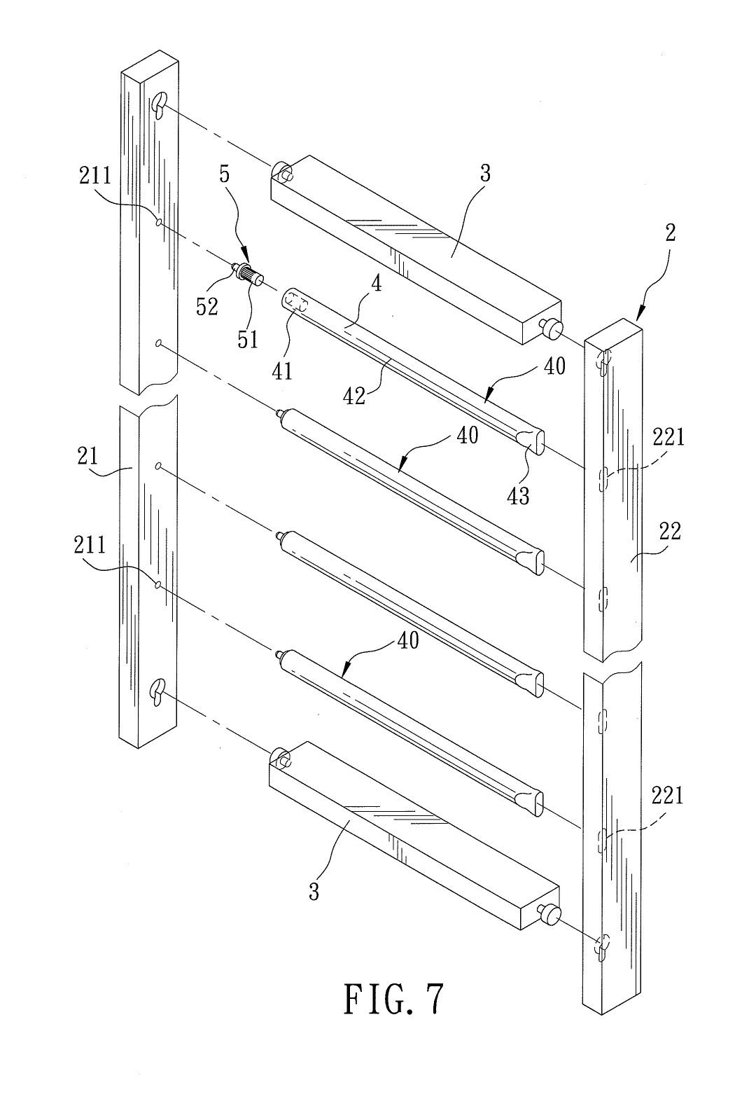

Referring to FIGS. 7 to 9, the second preferred embodiment of the modular tube assembly according to the present invention has a structure similar to that of the first embodiment. The main difference between this embodiment and the previous embodiment resides in that each first engaging hole 211 is larger than the cross-section of the movable portion 52 of the corresponding spring-loaded pin 5, but is smaller than the cross-section of the connecting segment 41 of the corresponding connecting rod 4.

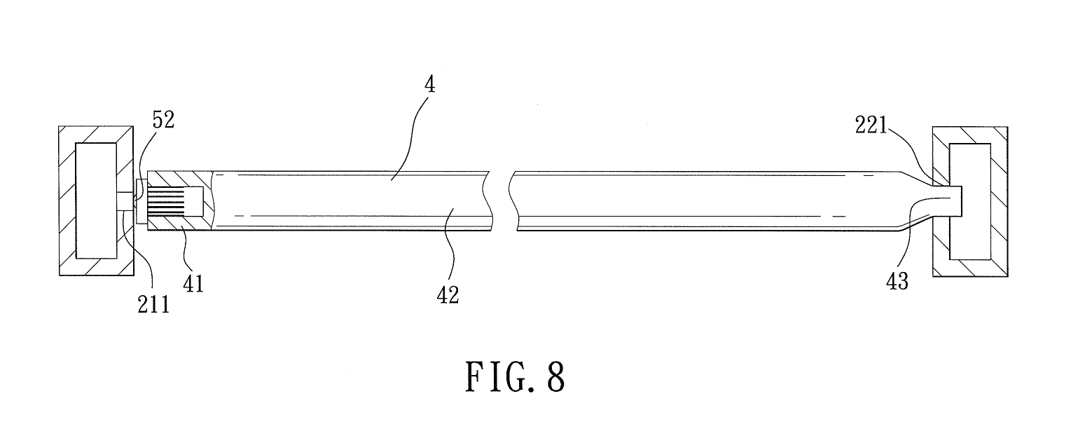

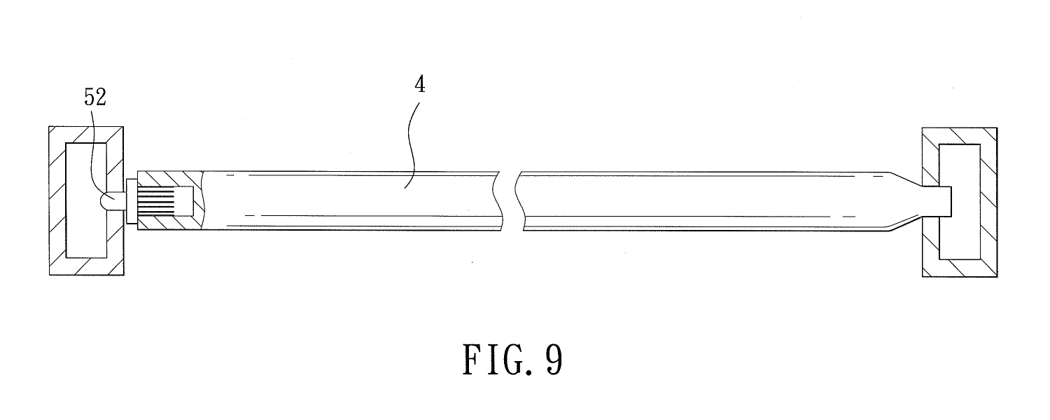

Each connecting rod unit 40 is assembled to the upright tube unit 2 by inserting the insert segment 43 into the corresponding second engaging hole 221, and moving the connecting rod 4 together with the corresponding spring-loaded pin 5 toward the corresponding first engaging hole 211. During the movement of the connecting rod 4 toward the corresponding first engaging hole 211, the movable portion 52 is urged by an outer surface of the first upright tube 21 to the retracted position, and slides along the outer surface. When the movable portion 52 is moved to the corresponding first engaging hole 211 (see FIG. 8), it is biased by the restoring force of the spring member 53 to the extended position (see FIG. 9) to engage the corresponding first engaging hole 211, thereby completing the coupling of the connecting rod unit 40 to the upright tube unit 2. To disassemble each connecting rod unit 40 from the upright tube unit 2, the coupling rods 3 have to be removed from the upright rod unit 2 first so that the first upright tube 21 can be moved away from the second upright tube 22, thereby permitting the removal of the connecting rod units 40. The second preferred embodiment has the same advantages as those of the first preferred embodiment.

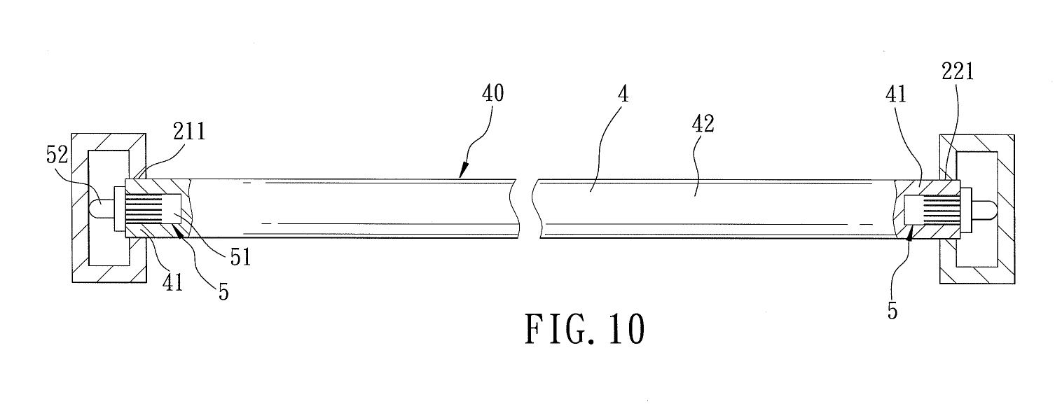

As shown in FIG. 10, the third preferred embodiment of the modular tube assembly according to the present invention has a structure similar to that of the first preferred embodiment. The main difference between this embodiment and the first preferred embodiment resides in the configuration of the connecting rod unit 40. The connecting rod 4 of each connecting rod units 40 has a symmetrical structure that includes the main segment 42 and two connecting segments 41 formed respectively at the first and second ends of the connecting rod 4, connected respectively to opposite ends of the main segment 42, and corresponding respectively in position to the respective pair of the registered first and second engaging holes 211, 221. Two spring-loaded pins 5 are provided to be inserted respectively into the connecting segments 41. Each second engaging hole 221 of the second upright tube 22 is formed as a round hole larger than the cross-section of the respective connecting segment 41.

Each connecting rod unit 40 can be coupled to the upright tube unit 2 by inserting one of the first and second ends of the connecting rod 4 into the corresponding first or second engaging hole 211, 221, pushing the movable portion 52 of the corresponding spring-loaded pin 5 to the retracted position, and then moving the connecting rod 4 longitudinally to extend the other one of the first and second ends thereof into the corresponding first or second engaging hole 211, 221, such that the retracted movable portion 52 of the spring-loaded pin 5 in the one of the first and second ends of the connecting rod 4 is released to move back to the extended position, thereby finishing the coupling of the connecting rod unit 40 to the upright tube unit 2. The third preferred embodiment has the same advantages as those of the first preferred embodiment.

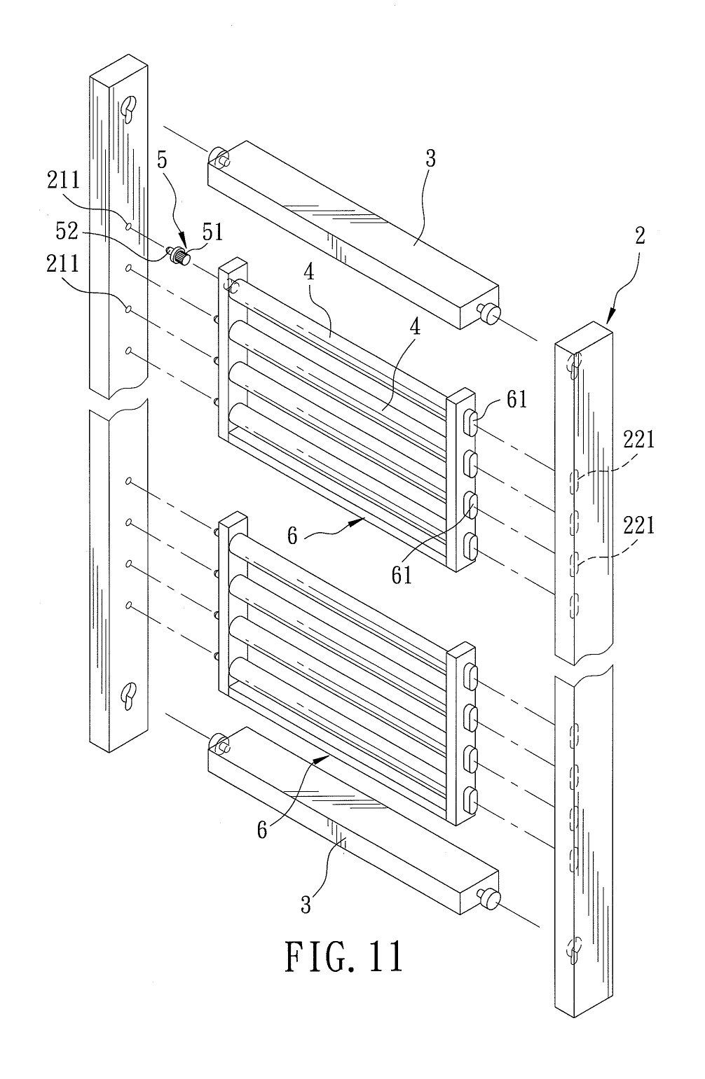

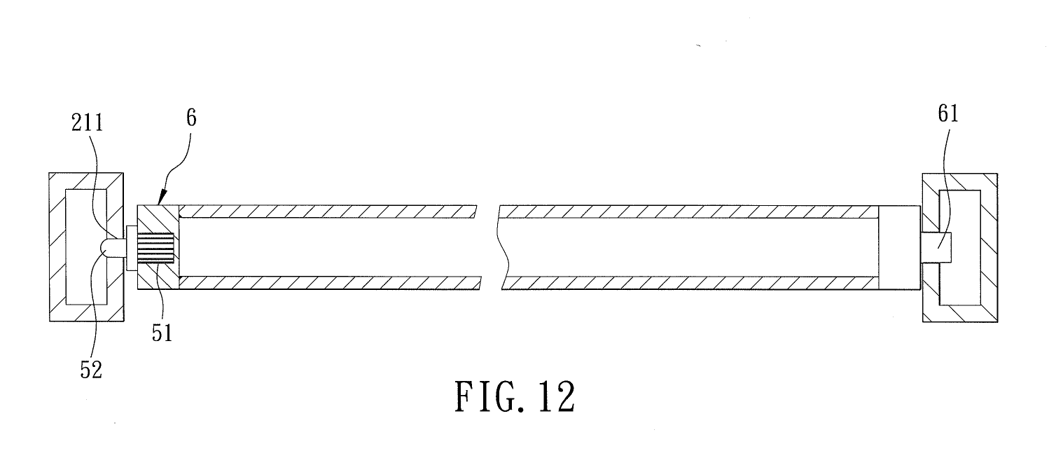

Referring to FIGS. 11 and 12, the fourth preferred embodiment of the modular tube assembly according to the present invention has a structure similar to that of the second embodiment. The main difference between this embodiment and the previous embodiment resides in the configuration of the connecting rods 4. In this embodiment, each connecting rod 4 is a straight rod without the connecting segment 41 and the insert segment that are illustrated in the second preferred embodiment. The modular tube assembly further comprises a plurality of U-shaped support frames 6. Each support frame 6 is connected to four connecting rods 4, and has a first side portion connected to the first ends of the connecting rods 4 and a second side portion connected to the second ends of the connecting rods 4. The first side portion of each support frame 6 is mounted with four of the spring-loaded pins 5 in a manner that the securing portions 51 thereof are secured to the first side portion at positions corresponding to the connecting rods 4, and that the movable portions 52 thereof engage respectively and separably the corresponding first engaging holes 211. The second side portion of each support frame 6 is mounted with four insert members 61 that correspond in position to the second ends of the connecting rods 4, and that engage respectively, separably and non-rotatably the corresponding second engaging holes 221. By coupling the insert members 61 to the corresponding second engaging holes 221, and sliding the movable portions 52 along the outer surface of the first upright tube 21 to engage respectively the corresponding first engaging holes 211, each support frame 6, together with the corresponding connecting rods 4 and the spring-loaded pins 5, can be assembled to the upright tube unit 2. Each support frame 6 can be removed from the upright tube unit 2 after the removal of the coupling rods 3 from the upright rod unit 2.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A modular tube assembly comprising:
first and second upright tubes spaced apart from each other, each of said first and second upright tubes being formed with at least one engaging hole, said at least one engaging hole of said first upright tube being registered with said at least one engaging hole of said second upright tube; and
at least one connecting rod unit including
a connecting rod interconnecting said first and second upright tubes, and having a first end that corresponds in position to said at least one engaging hole of said first upright tube, and a second end that is longitudinally opposite to said first end and that corresponds in position to said at least one engaging hole of said second upright tube, and
at least one spring-loaded pin having a securing portion that is secured to one of said first and second ends of said connecting rod, and a movable portion that is movable resiliently relative to said securing portion and that engages removably said at least one engaging hole of a respective one of said first and second upright tubes.

2. The modular tube assembly as claimed in claim 1, wherein:
said first upright tube is further formed with at least one first positioning hole;
said second upright tube is further formed with at least one second positioning hole; and
said modular tube assembly further comprises at least one coupling rod having a first end portion that engages said at least one of said first positioning hole, and a second end portion that is longitudinally opposite to said first end portion and that engages said at least one of said second positioning hole.

3. The modular tube assembly as claimed in claim 2, wherein:
each of said first and second positioning holes has a main hole portion, and an extending hole portion extending downwardly from and having a width smaller than said main hole portion;
said at least one coupling rod has a main part having longitudinally opposite ends that are connected respectively to said first and second end portions, each of said first and second end portions having
a neck part that has a cross-section smaller than said extending hole portion of a respective one of said first and second positioning holes, that extends through said extending hole portion of the respective one of said first and second positioning holes, and that has an inner end connected to a respective one of said ends of said main part and an outer end longitudinally opposite to said inner end, and
a head part that is connected to said outer end of said neck part, and that has a cross-section larger than said extending hole portion of the respective one of said first and second positioning holes.

4. The modular tube assembly as claimed in claim 2, wherein said first and second positioning holes are formed above said first and second engaging holes.

5. The modular tube assembly as claimed in claim 2, wherein said first and second positioning holes are formed below said first and second engaging holes.

6. The modular tube assembly as claimed in claim 1, wherein said connecting rod of said at least one connecting rod unit has
at least one connecting segment formed at one of said first and second ends thereof, and secured to and having a cross-section larger than that of said securing portion of said at least one spring-loaded pin, and
a main segment connected to said at least one connecting segment.

7. The modular tube assembly as claimed in claim 6, wherein:
said at least one connecting rod unit includes one of said spring-loaded pin; and
said connecting rod has one of said connecting segment formed at said first end thereof, and an insert segment formed at said second end thereof, connected to said main segment, having a cross-section smaller than that of said main segment, and inserted separably into said at least one engaging hole of said second upright tube.

8. The modular tube assembly as claimed in claim 7, wherein the cross-section of said insert segment of said connecting rod is configured to be substantially identical to said at least one engaging hole of said second upright tube such that said connecting rod is inserted separably and non-rotatably into said at least one engaging hole of said second upright tube.

9. The modular tube assembly as claimed in claim 8, wherein said at least one engaging hole of said second upright tube is formed as an elongated hole, and said insert segment of said connecting rod has an elongated cross-section.

10. The modular tube assembly as claimed in claim 6, wherein said at least one connecting segment of said connecting rod of said at least one connecting rod unit has a cross-section smaller than a corresponding one of said engaging holes in said first and second upright tubes.

11. The modular tube assembly as claimed in claim 6, wherein:
said at least one connecting segment of said connecting rod of said at least one connecting rod unit has a cross-section larger than said at least one engaging hole of the respective one of said first and second upright tubes; and
said movable portion of said at least one spring-loaded pin of said at least one connecting rod unit has a cross-section smaller than said at least one engaging hole of the respective one of said first and second upright tubes.

12. The modular tube assembly as claimed in claim 1, wherein:
said modular tube assembly comprises a plurality of said connecting rod units, and further comprises at least one support frame that has a first side portion connected to said first ends of said connecting rods and a second side portion connected to said second ends of said connecting rods;
each of said first and second upright tubes is formed with a plurality of said engaging holes; and
said securing portions of said spring-loaded pins of said connecting rod units are secured to said first side portion of said at least one support frame and engage removably and respectively said engaging holes of a respective one of said first and second upright tubes.

13. The modular tube assembly as claimed in claim 12, wherein said second side portion of said at least one support frame is provided with a plurality of insert members that engage separably and respectively said engaging holes of said second upright tube.

14. The modular tube assembly as claimed in claim 13, wherein said insert members of said at least one support frame has a cross-section configured to be substantially identical to said engaging holes of said second upright tube such that said insert members are inserted separably and non-rotatably into said engaging holes of said second upright tube.

15. The modular tube assembly as claimed in claim 1, wherein:
said securing portion of said at least one spring-loaded pin of said at least one connecting rod unit includes
an inner wall disposed in said connecting rod,
a hollow outer wall spaced apart from said inner wall and connected to a corresponding one of said first and second ends of said connecting rod, and
an intermediate wall interconnecting said inner and outer walls;
said movable portion of said at least one spring-loaded pin of said at least one connecting rod unit extends movably through said outer wall; and
said at least one spring-loaded pin further includes a spring member disposed in said securing portion and having opposite ends that abut respectively and resiliently against said inner wall and said movable portion.
